(19) United States
(12) Patent Application Publication
(10) Pub. No.: US 2025/0299118 A1
(43) Pub. Date: Sep. 25, 2025

(54) DIAGNOSING, CONFIGURING AND COMMISSIONING ROOM DEVICES IN A PROPERTY

(71) Applicant: Honeywell International Inc., Charlotte, NC (US)

(72) Inventors: Aditi Choudhary, Pune (IN); Haresh Chouksey, Oune (IN); Narayanaswamy Bandi, Bangalore (IN); Ryan Gardner, Niantic, CT (US); Sachin Gavhane, Pune (IN); Vishnu MR, Malappuram (IN); Michael Sobanko, Oakdale, CT (US); Devanshu Dugar, Kolkata (IN); Neha Jaitpal, San Diego, CA (US)

(21) Appl. No.: 19/082,695

(22) Filed: Mar. 18, 2025

(30) Foreign Application Priority Data
Mar. 19, 2024 (IN) 202411020466

(51) Int. Cl. G06Q 10/0631; F24F 11/49; F24F 11/52; F24F 11/58; G06Q 50/12

(52) U.S. Cl. CPC G06Q 10/0631; F24F 11/49; F24F 11/52; F24F 11/58; G06Q 50/12

(57) ABSTRACT

Methods and systems for configuring guest room control devices in hotel facilities. A user interface displays a guest room control device type selector, guest room selector, and configuration command selector. A user selects one or more guest room control device types, guest rooms, and a configuration command. A configuration command message delivers the selected command to guest room control devices of the selected types in the selected rooms to update device configurations. The devices control equipment associated with respective guest rooms. Status of command execution can be monitored and failed commands can be re-run. Configuration settings include temperature deadbands for different room occupancy states. In another method, a guest room control device copies configuration settings from a remote device over a mesh network and controls room equipment using the updated configuration.

### RELATED APPLICATIONS

This application claims the benefit of Indian Provisional Application No. 202411020466, filed Mar. 19, 2024, which application is incorporated by reference in its entirety.

### TECHNICAL FIELD

The present disclosure relates generally to building systems within a property, and more particularly to diagnosing, configuring and/or commissioning room devices that operate as part of the building systems within the property.

### BACKGROUND

A property such as a hotel can include a number of guest rooms. Each of the rooms may include one or more devices that control operation of particular features within the room. Each of these devices may be considered to be controllers. The various controllers in the guest room may work together, so that a command such as “I want to sleep”, or perhaps “prepare for bed” results in the thermostat controller reducing the temperature setpoint to a cooler temperature for sleeping, the lighting controller turning off the lights and the window treatment controller closing the window treatments. A command such as “time to wake up” may result in the thermostat controller increasing the temperature setpoint to a more comfortable temperature for being out of bed, the lighting controller turning on the lights and the window treatment controller opening the window treatments. These are just examples. It will be appreciated that each of the controllers in each of the guest room will need to be configured, commissioned and maintained, which may be time consuming, tedious and error prone. What would be desirable are systems and methods for more easily configuring, commissioning, and/or maintaining these devices.

### SUMMARY

The present disclosure relates generally to building systems within a property, and more particularly to diagnosing, configuring and/or commissioning room devices that operate as part of the building systems within the property. An example may be found in a method for configuring one or more guest room control devices in each of a plurality of guest rooms of a hotel facility. Each of the guest room control devices is operatively coupled to a server over a network and each of the guest room control devices is configured to control one or more pieces of equipment associated with the respective guest room. The illustrative method includes displaying on a display a user interface that includes a guest room control device type selector, a guest room selector and a configuration command selector. A selection of one or more guest room control device types is received from a user using the guest room control device type selector, resulting in one or more selected guest room control device types. A selection of one or more guest rooms is received from the user using the guest room selector, resulting in one or more selected guest rooms of the hotel facility. A selection of a configuration command from a plurality of available configuration commands is received from the user using the configuration command selector, resulting in a selected configuration command. A configuration command message is then sent over the network that delivers the selected configuration command to each of the guest room control devices that are of the selected guest room control device types in each of the selected guest rooms, that when executed by the respective guest room control device, updates a configuration of the respective guest room control device according to the selected configuration command.

Another example may be found in a system. The system includes one or more guest room control devices in each of a plurality of guest rooms of a hotel facility. Each of the guest room control devices is configured to control one or more pieces of equipment associated with the respective guest room. The illustrative system includes a display and a controller that is operatively coupled to the display and to the one or more guest room control devices. The controller is configured to display on the display a user interface that includes a guest room control device type selector, a guest room selector and a configuration command selector. The controller is configured to receive from a user a selection of one or more guest room control device types using the guest room control device type selector, resulting in one or more selected guest room control device types. The controller is configured to receive from the user via the user interface a selection of one or more guest rooms using the guest room selector, resulting in one or more selected guest rooms of the hotel facility. The controller is configured to receive from the user via the user interface a selection of a configuration command from a plurality of available configuration commands using the configuration command selector, resulting in a selected configuration command. The controller is configured to send a configuration command message that delivers the selected configuration command to each of the guest room control devices that are of the selected guest room control device types in each of the selected guest rooms, that when executed by the respective guest room control device, updates a configuration of the respective guest room control device according to the selected configuration command.

Another example may be found in a method for configuring a guest room control device in a guest room of a hotel facility. The guest room control device has a user interface and is operatively coupled to one or more remote guest room control devices of other guest rooms of the hotel facility via a mesh network. The method includes selecting a remote guest room control device associated with one of the other guest rooms of the hotel facility via the user interface of the guest room control device. A configuration copy command of the guest room control device is initiated via the user interface of the guest room control device. In response to initiating the configuration copy command, a plurality of configuration settings are received from the selected remote guest room control device over the mesh network. The received configuration settings are stored in a memory of the guest room control device, resulting in an updated configuration for the guest room control device. One or more pieces of equipment associated with the guest room are controlled using the guest room control device having the updated configuration.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system;

FIG. 2 is a schematic block diagram showing an example of the illustrative system of FIG. 1;

FIGS. 3A and 3B are flow diagrams that together show an illustrative method for configuring one or more guest room control devices;

FIG. 4 is a flow diagram showing an illustrative method for configuration a guest room control device;

FIG. 5 is a schematic diagram providing an example of performing an illustrative initial configuration;

FIG. 6 is a schematic diagram providing an example of performing an illustrative advanced configuration;

FIG. 7 is a schematic diagram providing an example of performing a room copy;

FIG. 8A is an illustrative screen capture and FIGS. 8B, 8C, 8D, and 8E provide example pull-down menus referenced in FIG. 8A;

FIG. 8F is an illustrative screen capture that may be displayed in response to making a selection in FIG. 8E;

FIG. 9 is an illustrative screen capture;

FIG. 10 is an illustrative screen capture; and

FIG. 11 is an illustrative screen capture.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

It will be appreciated that each of the controllers in each of the guest rooms of a hotel will need to be configured, commissioned and maintained. In some cases, some or all of these controllers may be configured, commissioned and/or maintained from a remote location. In some cases, at least some of these controllers may be operably coupled to an in-room network that is itself operably coupled to a larger facility network. In some cases, at least some of these controllers may be operably coupled to a mesh network in which a plurality of controllers and other devices communicate wirelessly with their closest neighbors. Each of those neighbors in turn communicate wirelessly with their closest neighbors, and so on. Accordingly, a large number of controllers and other devices are able to communicate throughout the facility.

Because of the ability for the controllers and other devices to communicate throughout the facility, it is possible to commission, configure and even diagnose at least some of the controllers and/or other devices from a remote location. In some cases, initiating commands may be provided to each of the controllers and other devices from a cloud-based supervisor, for example. A cloud-based supervisor may allow an individual to login to see what is going on with each of a number of different facilities within a portfolio of facilities. For example, an individual may be able to view information for each of a number of hotels in a hotel portfolio. In some cases, the cloud-based supervisor may provide the user with aggregate information for each of the hotels, including energy consumption and other useful parameters. The cloud-based supervisor may allow the user to drill down, to view information for a particular hotel, a portion of the hotel, a floor of the hotel, or even a single room of the hotel. The cloud-based supervisor may allow the user to view temperature setpoints and/or other parameters, and may allow the user to temporarily alter temperature setpoints and/or other settings for a particular room, or for a group of rooms. These are just examples.

As an example, a Command Center feature of INNCOM Direct cloud supervisor enables INNCOM Room devices (e.g. thermostats) to securely configure, commission and provide mechanism to diagnose devices issues by firing (e.g. sending) initiating commands from the INNCOM Direct cloud supervisor. Commissioning of Rooms devices is traditionally done by an on-site engineer, and this feature allows the remote commission of devices from a cloud, sometimes in a one-to-many device format. The INNCOM Direct cloud supervisor may: (1) have the ability to remotely fire (e.g. send) commissioning, diagnostic and/or other commands for Hospitality based Room's field devices; (2) provide status and timestamp of all the commands in current login session; (3) maintain an audit log for commands fired (e.g. sent) in past from various technician to track commands; (4) support command either in Query (Duplex communication) or Event (half duplex) form, wherein a query provides the command and triggers feedback from the room devices, whereas an event type of command provides the command but does not require feedback; (5) send commands in broadcast and unicast fashion with various combinations such as a single type of device in all the rooms; multiple devices in single room, multiple devices in multiple rooms; and/or (6) have the ability to control, commission and make configuration changes for any of the sites (e.g. hotels) located globally through a single user interface. These are just examples.

### Room Copy

Many limited-service hotel owners want to make an investment in an online energy management solution for their guestroom and common area HVAC systems to meet brand sustainability costs and reduce their energy costs. However, the high upfront cost of equipment, and complicated on-site installation, deployment, commissioning, replacement and maintenance for the disparate building wide solutions has made limited-service hotel owners hesitant to invest in online energy management solutions.

During commissioning and/or maintenance of the hotel, a technician may manually configure a controller such as a thermostat in a first hotel room. A second hotel room may be essentially identical to the first hotel room. According, and in some cases, the technician may go to the second hotel room, after having configured the thermostat in the first hotel room, and select an option via the user interface of the thermostat in the second hotel room that instructs the thermostat in the second hotel room to gain access to the configuration of the thermostat in the first hotel room (e.g., via a mesh or other network), copy and install the configuration on the thermostat in the second hotel room. That way, the thermostat in the second hotel room can be quickly and easily configured. Alternatively, or in addition, after having configured the thermostat in the first hotel room, the technician may select, via the user interface of the thermostat in the first hotel room, one or more other hotel rooms including the second hotel room. The thermostat in the first hotel room may then initiate the copy and installation of the configuration of the thermostat in the first hotel room to the thermostats of the one or more other selected hotel rooms. It is also contemplated that the configuration of the thermostat in the first hotel room can be copied from the thermostat in the first hotel room to any of a number of selected second hotel rooms using the cloud-based supervisor, for example.

Once completed, the thermostat in the subsequent room may reinitialize/restart and may function with the new settings to control the subsequent room (e.g. control the HVAC system) accordingly. Pulling the data from a user selected room, allows the user to identify an identical and known good room configuration to copy, which eliminates the need for a push or broadcasted method, where mistakes can be easily propagate property wide risking severe HVAC equipment malfunction and or guest complaints due to incorrectly or non-configured HVAC equipment. In some cases, the parameters that are copied may include HVAC type, fan speed, User Target Temperature Range (tt), Room Unoccupied Delta Temperature (dLt), Room Unoccupied Time (Uot), Room Unrented Setback (UrS), Room Unrented Tome (Urt), Energy Management Settings (EMS), and/or other network and/or hotel specific settings. These are just examples.

Such a room copy provides a full back up of specific room type configurations such as HVAC equipment type and energy management settings and strategies, without the need for a separate commission device such as a USB drive, flash memory, smart phone app, software tool, etc. Instead, room copy allows a novice, non-trained hotel staff member to easily configure a Thermostat utilizing a previous room's known good configuration settings. During installation, this reduces installation time and complexity and can eliminate mistakes. During routine maintenance and repair, this may allow an untrained user to easily replace a thermostat without knowing the HVAC type or thermostat configuration for that specific room by simply copying known good settings from the thermostat of an adjacent room to the newly installed replacement thermostat.

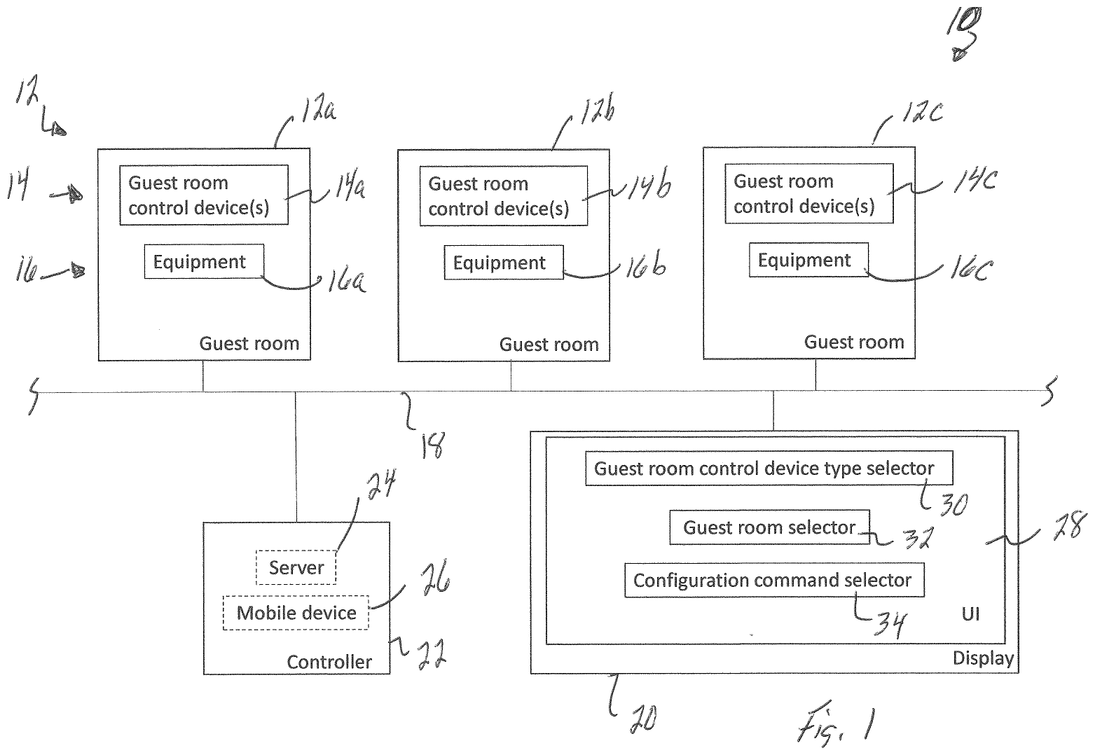

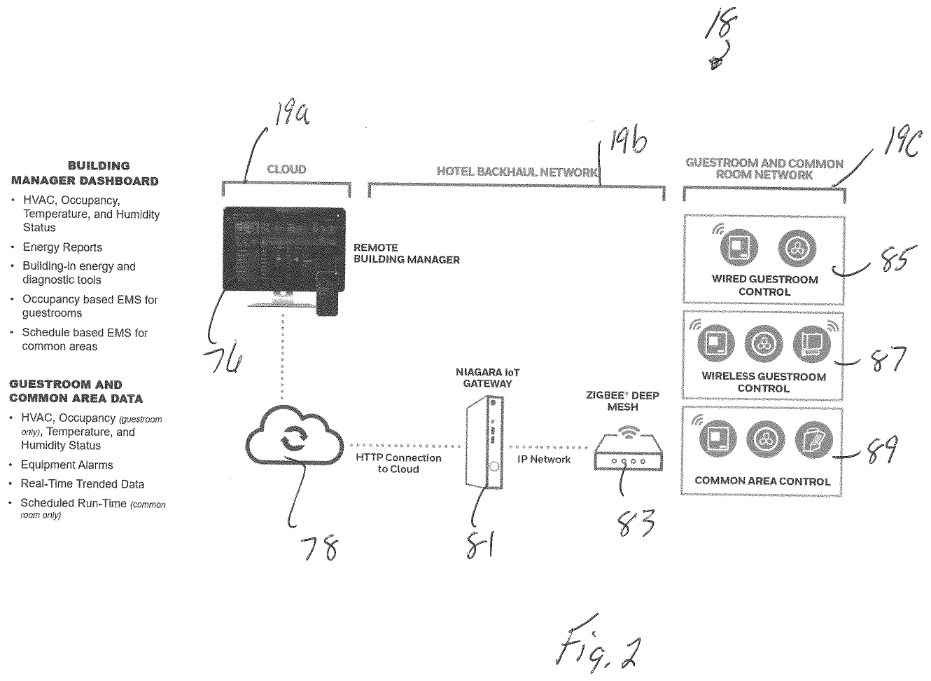

Turning now specifically to the Figures, where FIG. 1 is a schematic block diagram showing an illustrative system 10 that may be deployed within a property such as a hotel or motel that includes a number of guest rooms 12, individually labeled as 12a, 12b, and 12c. While a total of three guest rooms 12 are shown, this is merely illustrative, as the property may include any number of guest rooms 12 and may include considerably more than three guest rooms 12. Some hotels may include hundreds or even thousands of guest rooms 12, for example. Each of the guest rooms 12 include one or more guest room control devices 14, individually labeled as 14a, 14, and 14c, that are configured to control one or more pieces of equipment 16, individually labeled as 16a, 16b, and 16c, that are associated with the respective guest room 12. As an example, the guest room control device 14 may be a thermostat that controls operation of an HVAC unit (the equipment 16) associated with a particular guest room 12. As another example, the guest room control device 14 may be a lighting controller that controls operation of the lights (the equipment 16) that is associated with a particular guest room 12. Another example of a possible guest room control device 14 includes a window treatment controller that is configured to instruct one or more window treatments such as blinds or drapes to be automatically opened and closed.

Each of the guest rooms 12, and hence the guest room control devices 14 within each of the corresponding guest rooms 12, may be operably coupled with a network 18. In some cases, the network 18 may be a wired network. In some cases, the network 18 may include a number of devices such as the guest room control devices 14 joined together in a mesh network. In a mesh network, each device communicates wirelessly with another device with which the first device has a strong signal strength, and so on.

In some cases, the system 10 includes a display 20 and a controller 22 that is operatively coupled to the display 20 and to the one or more guest room control devices 14. In some cases, the controller 22 may be at least partially ensconced within a server 24. In some cases, the controller 22 may be at least partially ensconced within a mobile device 26, such as a tablet, a laptop computer, or a smartphone. In some cases, the controller 22 may be a distributed controller, with at least some of the functionality of the controller 22 disposed within the server 24, and perhaps with some of the functionality of the controller 22 disposed within the mobile device 26.

The controller 22 may be configured to display on the display 20 a user interface 28 that includes a guest room control device type selector 30, a guest room selector 32 and a configuration command selector 34. In some cases, the guest room control device type selector 30 may be a pull-down menu, or perhaps a box into which a user may type in a particular guest room control device type. In some cases, the guest room selector 32 may be a pull-down menu, or perhaps a box into which a user may type in a particular guest room number or range of guest room numbers. In some cases, the configuration command selector 34 may be a pull-down menu, or perhaps a box into which a user may type in a particular configuration command. The controller 22 is configured to receive from a user a selection of one or more guest room control device types using the guest room control device type selector 30, resulting in one or more selected guest room control device types. The controller 22 is configured to receive from the user via the user interface 28 a selection of one or more guest rooms 12 using the guest room selector 32, resulting in one or more selected guest rooms 12 of the hotel facility. The controller 22 is configured to receive from the user via the user interface 28 a selection of a configuration command from a plurality of available configuration commands using the configuration command selector 34, resulting in a selected configuration command.

The controller 22 is configured to send a configuration command message that delivers the selected configuration command to each of the guest room control devices 14 that are of the selected guest room control device types in each of the selected guest rooms 12, that when executed, updates a configuration of the respective guest room control device 14 according to the selected configuration command. In some cases, the selected configuration command may set in the respective guest room control device 14 a respective configuration parameter to a respective configuration value. In some cases, the respective configuration parameter may include a setpoint. In some cases, the respective configuration parameter may include a rented and occupied temperature deadband defined about the setpoint that is used when the guest room 12 is rented and occupied. In some cases, the respective configuration parameter may include a rented and unoccupied temperature deadband defined about the setpoint that is used when the guest room 12 is rented and unoccupied. In some cases, the respective configuration parameter may include an unrented temperature deadband defined about the setpoint that is used when the guest room 12 is unrented.

In some cases, the controller 22 may be configured to send an individual configuration command message to each of the guest room control devices 14 that are of the one or more selected guest room control device types in each of the selected guest rooms 12 for execution by the respective guest room control device 14. In some cases, the controller 22 may be configured to receive a status of execution of each of the individual configuration command messages from the respective guest room control devices 14 and to display the received status of execution of each of the individual configuration command messages via the user interface 28. The controller 22 may be configured to provide a run again selection option via the user interface 28 for those individual configuration command messages that have a status of execution that indicates the corresponding individual configuration command message did not successfully complete execution on the corresponding guest room control device 14.

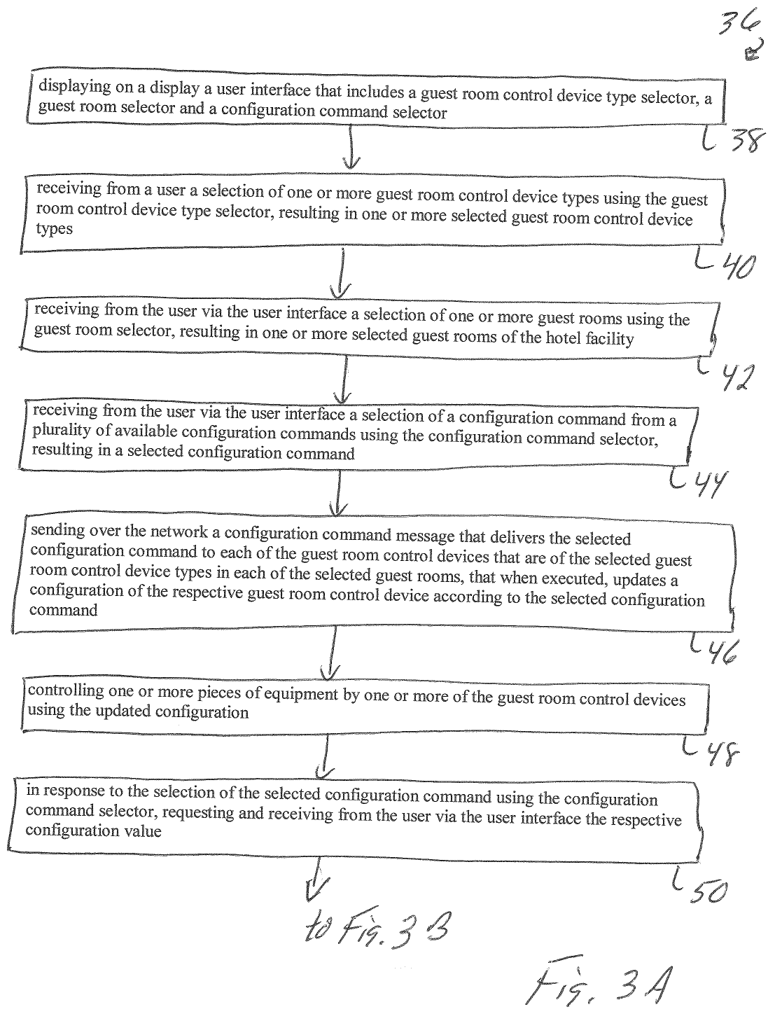

FIG. 2 is a schematic block diagram showing an example of the illustrative system of FIG. 1. In FIG. 2, the illustrative system includes a cloud-based portion 19a, a hotel network portion 19b, and a guestroom and common room network 19c. The cloud-based portion 19a connects a remote building manager 76, which may be located within the hotel or may be remotely located, with a cloud-based system 78. The hotel network portion 19b may include one or more gateways 81 that are configured to communicate with the cloud-based system 78 as well as forming an IP network with a mesh network gateway 83. The guestroom and common room network 19c, which is disposed locally within the hotel, for example, may be considered as including wired guestroom controls 85, wireless guestroom controls 87, and/or common area controls 89 which may be wired or wireless.

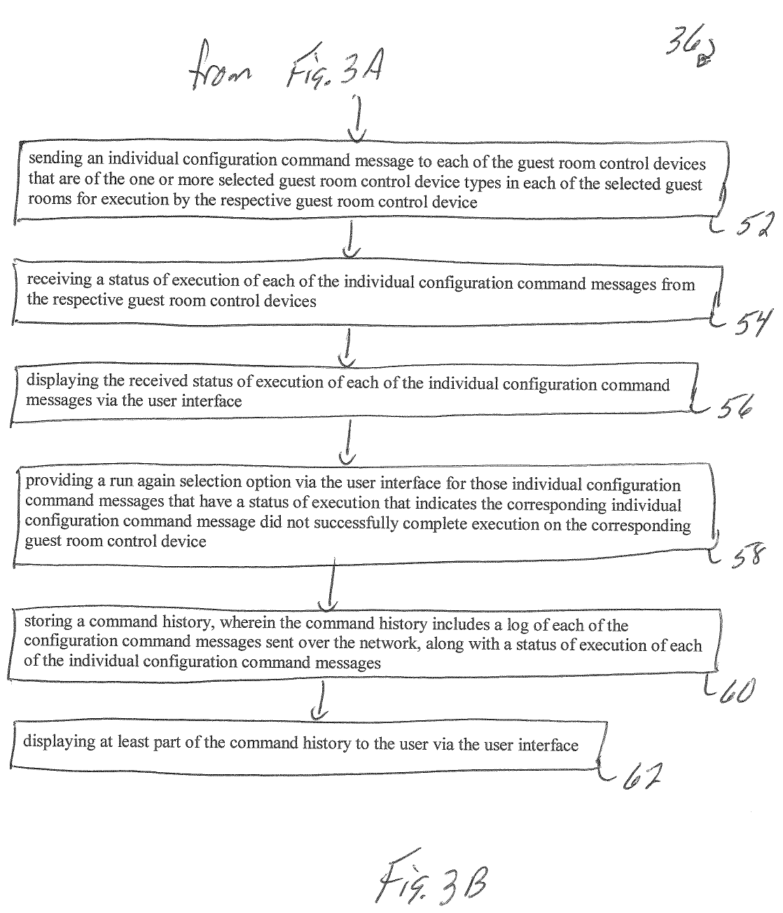

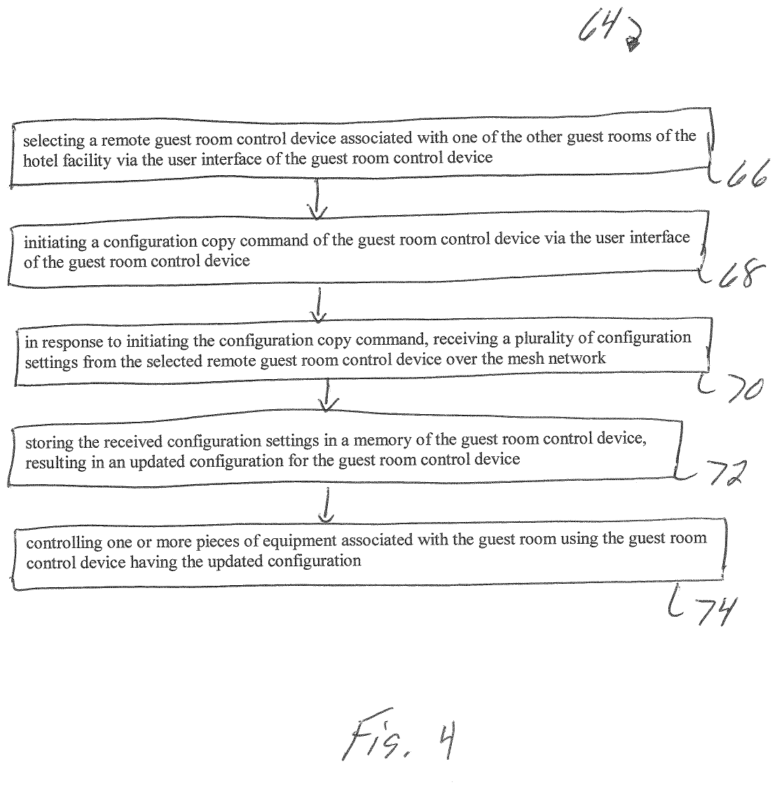

FIGS. 3A and 3B are flow diagrams that together show an illustrative method 36 for configuring one or more guest room control devices (such as the guest room control devices 14) in each of a plurality of guest rooms (such as the guest rooms 12) of a hotel facility. In the example shown, each of the guest room control devices is operatively coupled to a server (such as the server 24) over a network (such as the network 18) and each of the guest room control devices is configured to control one or more pieces of equipment (such as the equipment 16) that is associated with the respective guest room. The illustrative method 36 includes displaying on a display a user interface that includes a guest room control device type selector, a guest room selector and a configuration command selector, as indicated at block 38. In some cases, the guest room selector may allow the user to select the one or more selected guest rooms individually and/or may allow the user to select a predefined group of guest rooms. A selection of one or more guest room control device types is received from a user using the guest room control device type selector, resulting in one or more selected guest room control device types, as indicated at block 40. In some cases, the guest room control device types may include two or more of a primary thermostat device type, a secondary thermostat device type, a lighting control device type and a window shade controller device type. These are just examples.

A selection of one or more guest rooms is received from the user via the user interface using the guest room selector, resulting in one or more selected guest rooms of the hotel facility, as indicated at block 42. A selection of a configuration command from a plurality of available configuration commands is received from the user via the user interface using the configuration command selector, resulting in a selected configuration command, as indicated at block 44. A configuration command message that delivers the selected configuration command is sent over the network to each of the guest room control devices that are of the selected guest room control device types in each of the selected guest rooms, that when executed by the respective guest room control device, updates a configuration of the respective guest room control device according to the selected configuration command, as indicated at block 48. In some cases, each of the steps 38, 40, 42, and 44 are performed by a server such as the server 24. In some cases, one or more of the steps 38, 40, 42, and 44 may be performed by a mobile device such as the mobile device 26.

In some cases, the method 36 may include controlling one or more pieces of equipment by one or more of the guest room control devices using the updated configuration, as indicated at block 48. In some cases, the selected configuration command may set in the respective guest room control device a respective configuration parameter to a respective configuration value. In some cases, the respective configuration parameter may include one or more of a setpoint, a rented and occupied temperature deadband defined about the setpoint that is used when the guest room is rented and occupied, a rented and unoccupied temperature deadband defined about the setpoint that is used when the guest room is rented and unoccupied, and an unrented temperature deadband defined about the setpoint that is used when the guest room is unrented. In some cases, in response to the selection of the selected configuration command using the configuration command selector, the method 36 may include requesting and receiving from the user via the user interface the respective configuration value, as indicated at block 50.

Continuing on FIG. 3B, in some cases, the method 36 may include sending an individual configuration command message to each of the guest room control devices that are of the one or more selected guest room control device types in each of the selected guest rooms for execution by the respective guest room control device, as indicated at block 52. In some cases, the method 36 may further include receiving a status of execution of each of the individual configuration command messages from the respective guest room control devices, as indicated at block 54. The method 36 may further include displaying the received status of execution of each of the individual configuration command messages via the user interface, as indicated at block 56. The method 36 may include providing a “run again” selection option via the user interface for those individual configuration command messages that have a status of execution that indicates the corresponding individual configuration command message did not successfully complete execution on the corresponding guest room control device, as indicated at block 58.

In some cases, the method 36 may include storing a command history, wherein the command history includes a log of each of the configuration command messages sent over the network, along with a status of execution of each of the individual configuration command messages, as indicated at block 60. In some cases, at least part of the command history may be displayed to the user via the user interface, as indicated at block 62.

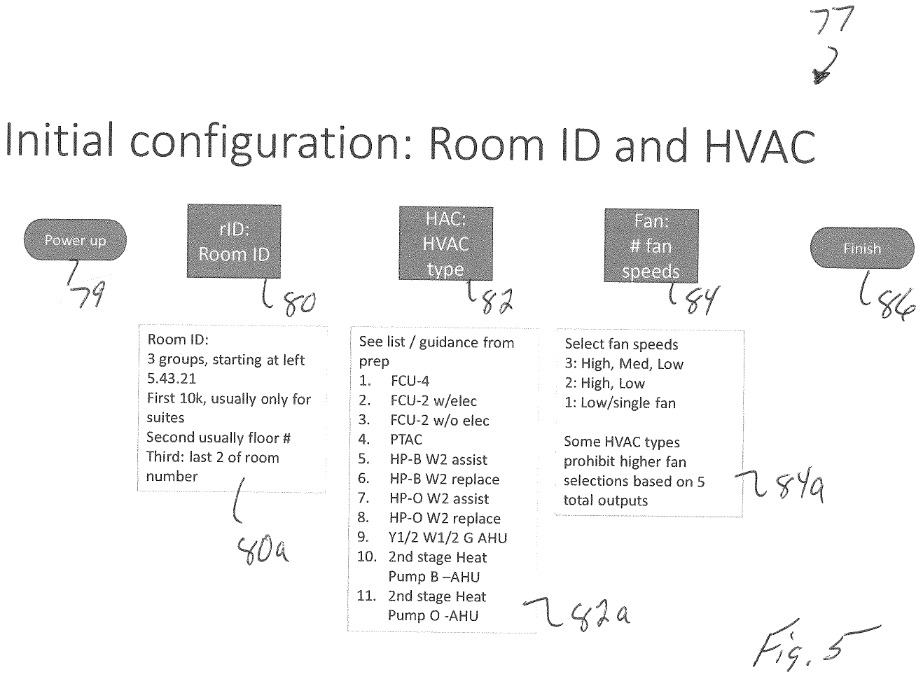

FIG. 4 is a flow diagram showing an illustrative method 64 for configuring a guest room control device (such as the guest room control devices 14) in a guest room (such as the guest rooms 12) of a hotel facility, wherein the guest room control device is operatively coupled to one or more remote guest room control device of other guest rooms of the hotel facility via a mesh or other network (such as the network 18), the guest room control device having a user interface (such as the user interface 28). The illustrative method 64 includes selecting a remote guest room control device associated with one of the other guest rooms of the hotel facility via the user interface of the guest room control device, as indicated at block 66. A configuration copy command of the guest room control device is initiated via the user interface of the guest room control device, as indicated at block 68. In response to initiating the configuration copy command, a plurality of configuration settings are received from the selected remote guest room control device over the mesh or other network, as indicated at block 70. The received configuration settings are stored in a memory of the guest room control device, resulting in an updated configuration for the guest room control device, as indicated at block 72. One or more pieces of equipment associated with the guest room are controlled using the guest room control device having the updated configuration, as indicated at block 74.

In some cases, the received configuration settings may include one or more of a rented and occupied temperature deadband defined about a setpoint that is used when the guest room is rented and occupied, a rented and unoccupied temperature deadband defined about the setpoint that is used when the guest room is rented and unoccupied, and an unrented temperature deadband defined about the setpoint that is used when the guest room is unrented. In some cases, the received configuration settings may include one or more of an HVAC type setting and a fan speed setting. These are just examples.

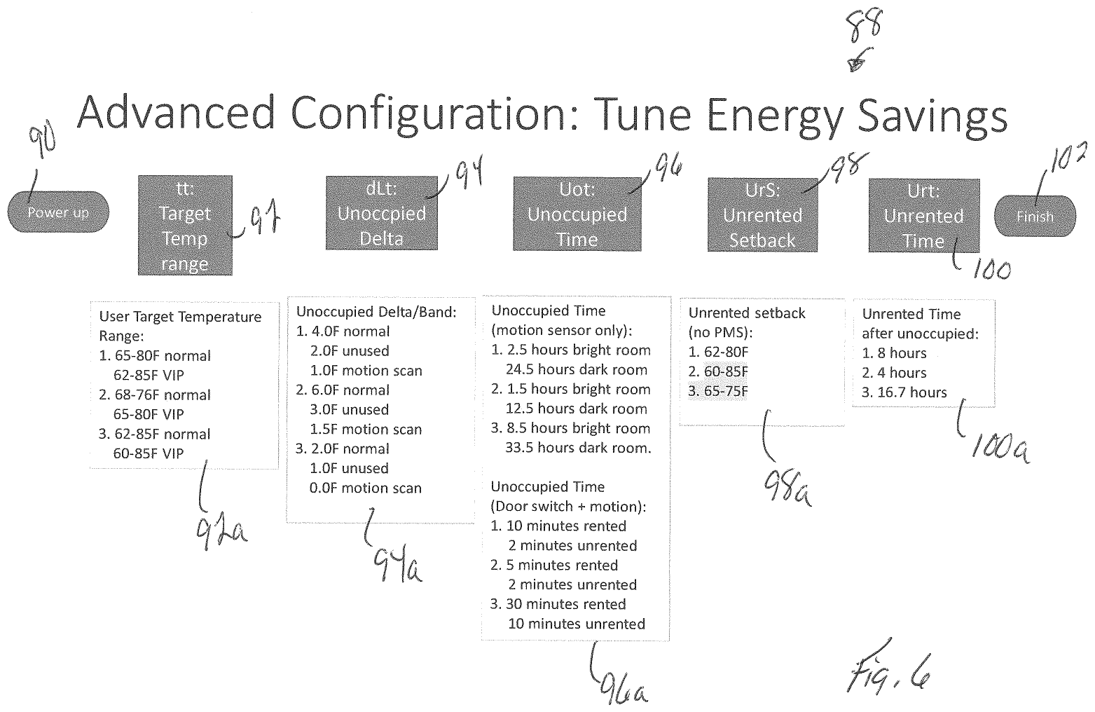

FIG. 5 is a schematic diagram providing an example of performing an illustrative initial configuration. An initial configuration process 77 begins with powering up, as indicated at block 79. A room ID is determined, as indicated at block 80. Examples of possible room IDs are shown at 80a. In some cases, a thermostat may have a simple three-character display, so Room ID may be abbreviated as rID. An HVAC type abbreviated as HAC is determined, as indicated at block 82. Examples of HVAC type are shown at 82a, along with a corresponding selection number. Information regarding fan speed is determined, as indicated at block 84. Examples of possible choices are shown at 84a. The initial configuration process 77 terminates at block 86.

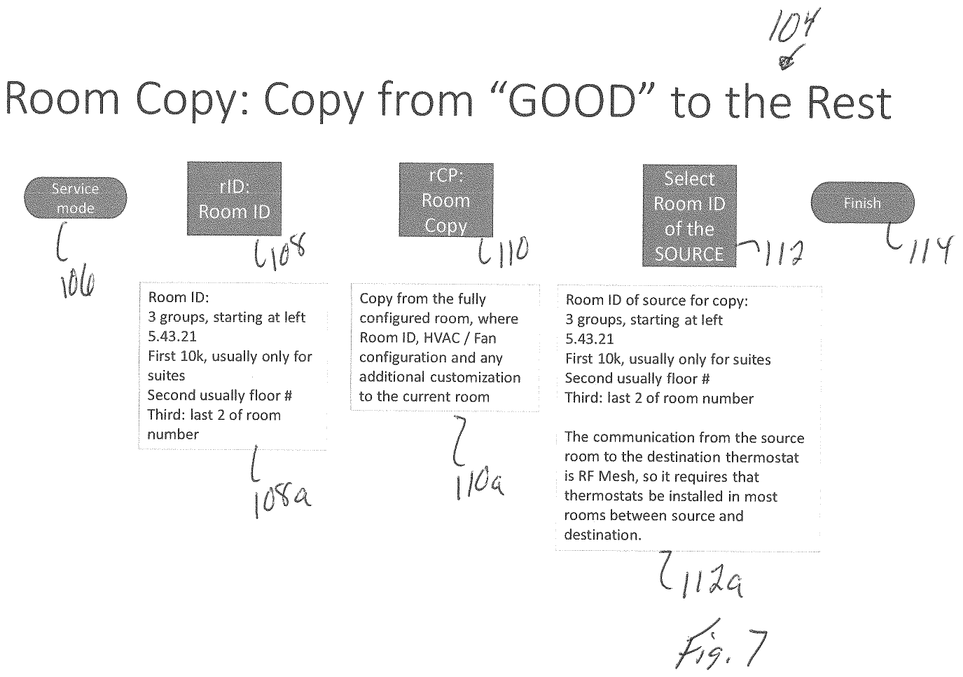

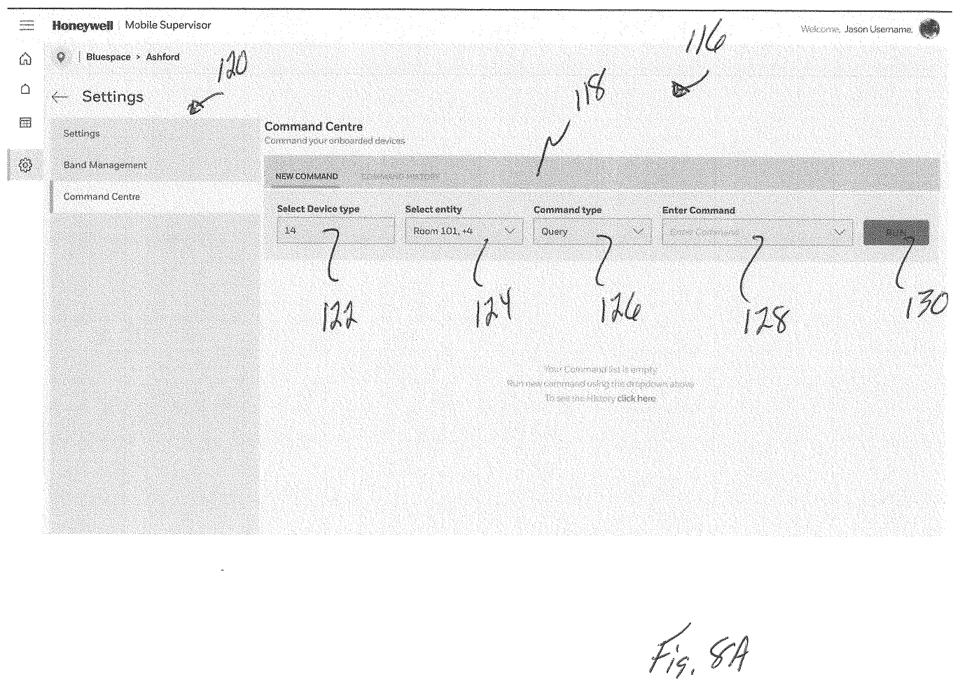

FIG. 6 is a schematic diagram providing an example of performing an illustrative advanced configuration. An advanced configuration process 88 begins with powering up, as indicated at block 90. A target temperature range abbreviated as tt is determined, as indicated at block 92. Examples of suitable target temperature ranges are shown at 92a. An Unoccupied Delta abbreviated as dLt is determined, as indicated at block 94. Examples of suitable unoccupied delta values are shown at 94a. An Unoccupied Time abbreviated as Uot is determined, as indicated at block 96. Examples of suitable unoccupied times are shown at 96a. An Unrented Setback abbreviated as UrS is determined, as indicated at block 98. Examples of suitable unrented setbacks are shown at 98a. An Unrented Time abbreviated as Urt is determined, as indicated at block 100. Examples of suitable unrented times are shown at 100a. The advanced configuration process 88 terminates at block 102.

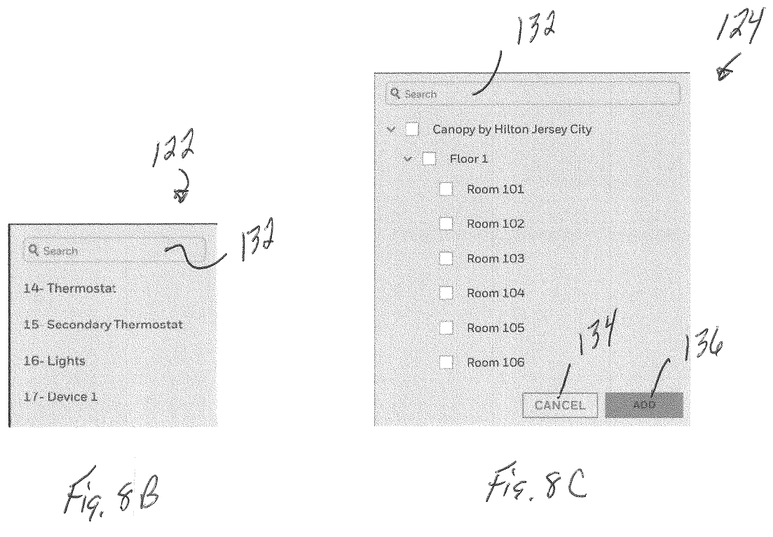

FIG. 7 is a schematic diagram providing an example of performing a room copy. A process 104 begins with entering a service mode, as indicated at block 106. A room ID abbreviated as rID is determined, as indicated at block 108. Examples of possible room IDs are shown at 108a. The process 104 includes selecting the Room Copy function abbreviated as rCP, as indicated at block 110. More information is shown at 110a. A source Room ID is selected, as indicated at block 112. More information is shown at 112a. The process 104 terminates at block 114.

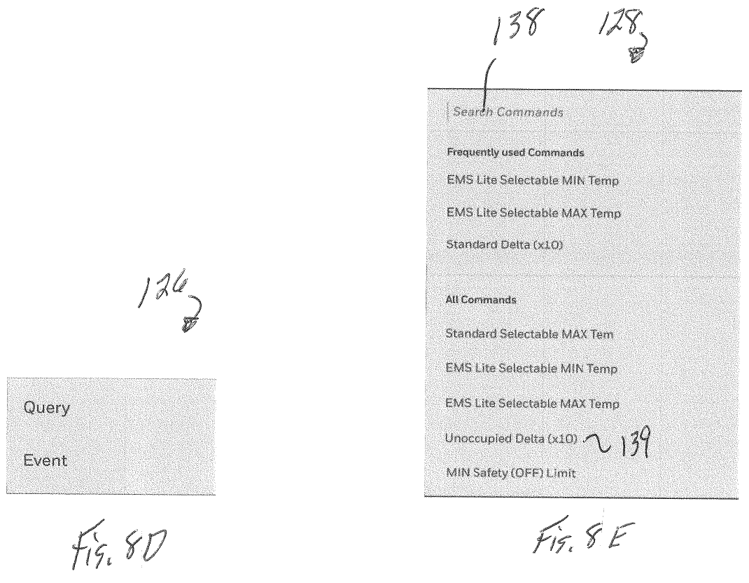

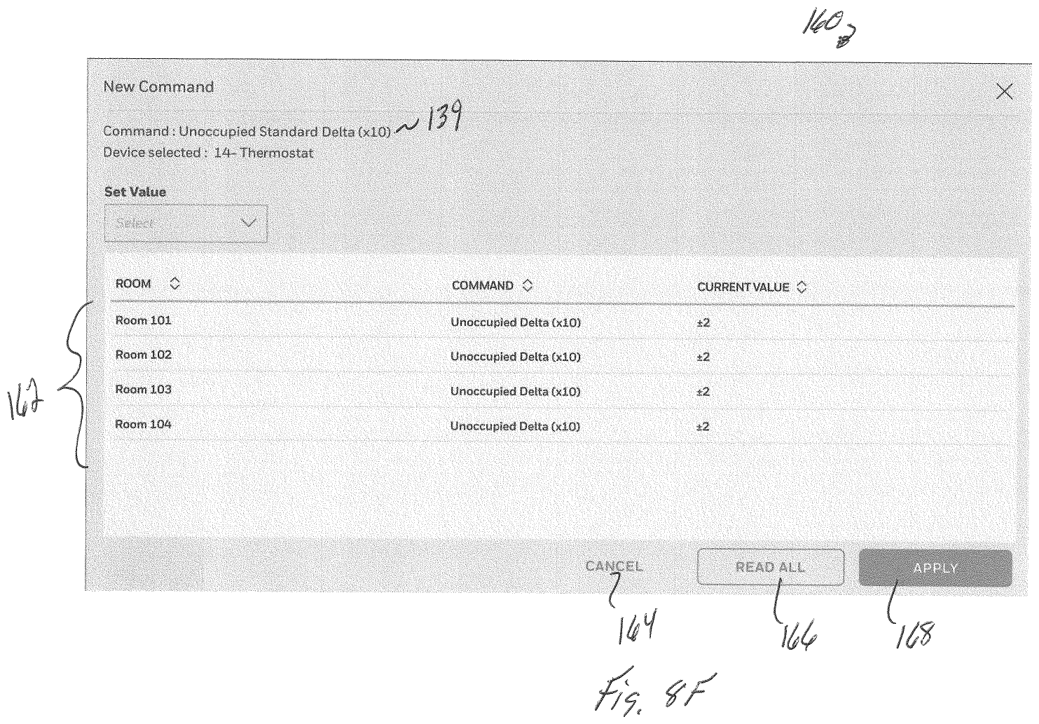

FIG. 8A is an illustrative screen capture showing a screen 116 that may be generated by the controller 22 and displayed on the display 20, for example. The illustrative screen 116 provides an overview of a Command Center that may be used to seamlessly command and control devices remotely and to keep track of the commands issued by the Command Center. The screen 116 includes a toolbar 118 that allows a user to select between NEW COMMAND and COMMAND HISTORY. As seen, NEW COMMAND is selected. The screen 116 also includes a settings section 120. With NEW COMMAND selected, the screen 116 displays a device type menu 122, a select entity (e.g. room) menu 124, a command type menu 126, an enter command menu 128 and a RUN button 130. In some cases, at least some of the menus 122, 124, 126, and 128 may be boxes that a user can type selections into directly. In some cases, at least some of the menus 122, 124, 126, and 128 may be pull-down menus, for example.

FIG. 8B shows at least some of the device types that may be displayed within the device type menu 122 and selected from. In some cases, the device type menu 122 may include a search option 132 that allows a user to enter a few characters identifying a particular device type, and the system may autogenerate options for the user to select from. FIG. 8C shows at least some of the entities (e.g. rooms) that may be displayed within the select entity menu 124. As shown in FIG. 8C, entities may be referenced within a hierarchal menu. For example, a particular hotel, then each of several floors within the hotel, and then several rooms on each floor of the particular hotel. In some cases, the device type menu 122 may include a CANCEL button 134 that may be used to cancel what the user is doing and an ADD Button 136 that may be used to inform the system to add the checked entities. The user may use the select entity menu 124 to select one or more rooms of the hotel.

FIG. 8D shows the command types that may be displayed within the command type menu 126. Queries are events in which a command is sent and a response is desired, while events are event in which a command is sent but no response is desired. FIG. 8E shows some of the commands that may be displayed within the enter command menu 128. The enter command menu 128 may include a search option 138 that allows a user to enter a few characters identifying a particular command, and the system may autogenerate options for the user to select from. In some cases, as shown, the commands may be divided out into frequently used commands and a listing of all commands. Depending on the length of the listing, the enter command menu 128 may include a scroll bar that allows a user to scroll through the possibilities. When a command is selected, one or more additional popups may be generated that allow the user to delve more deeply, such as to set one or more configuration values that are associated with the selected command. For example, FIG. 8F shows a screen 160 that may be displayed after the “Unoccupied Delta (x10)” command 139 is selected in FIG. 8E. The screen 160 shown in FIG. 8F allows the user to set a value for the Unoccupied Standard Delta parameter for use in the thermostat in the selected rooms. In some cases, the screen 160 may include a listing 162 of rooms, corresponding command and current values for each of the rooms. The screen 160 includes a CANCEL button 164, a READ ALL button 166, and an APPLY button 168 that may be used to navigate.

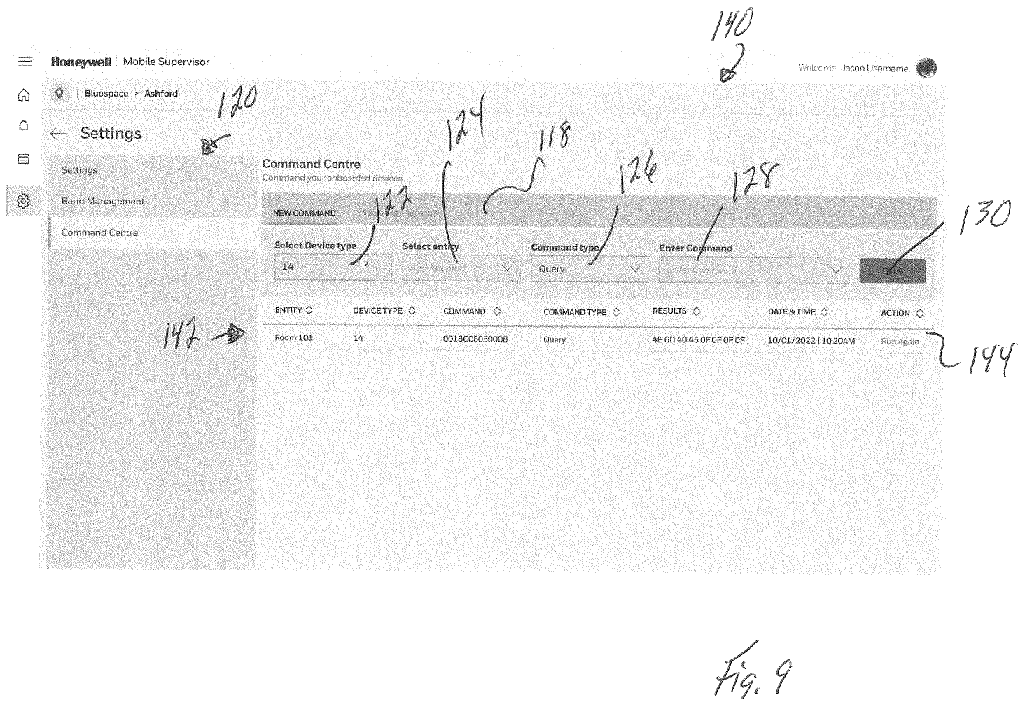

FIG. 9 is an illustrative screen capture 140 that is similar to the screen capture 116, but includes a row 142. The row 142 includes a selected entity (e.g. room), device type, command, and command type. The row 142 also includes results, and date and time. The results may indicate the status of execution of the command. In some cases, the row 142 includes an action 144 that, when selected, allows a user to rerun the same command for the same selected entity and device type.

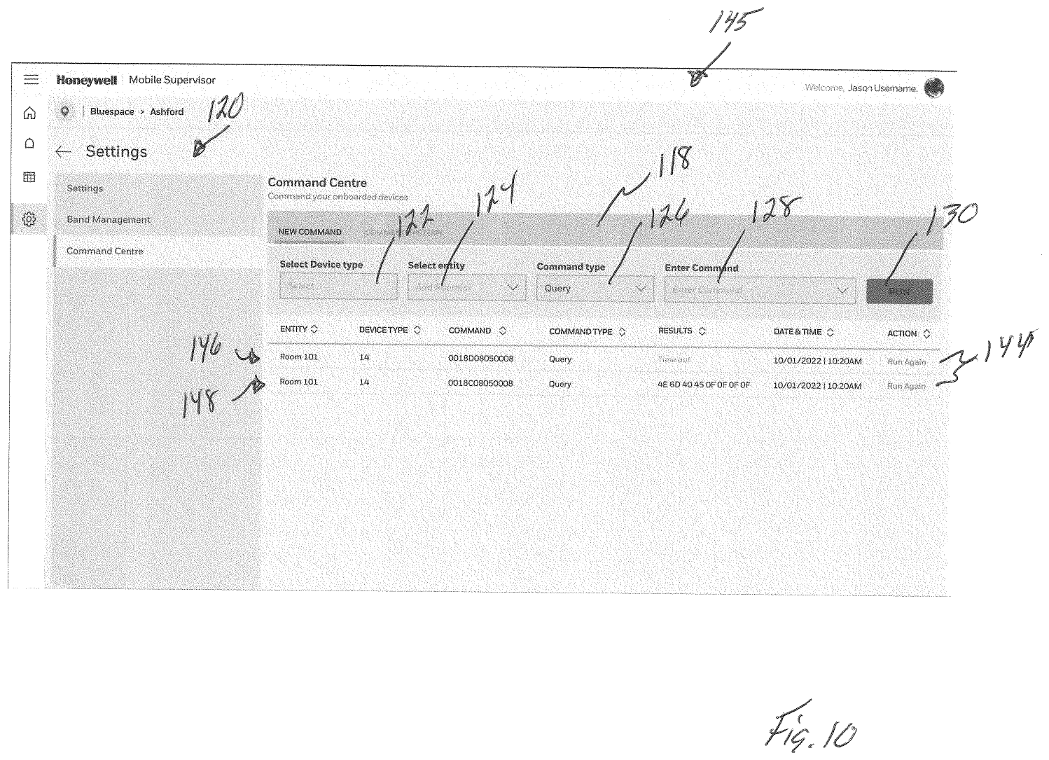

FIG. 10 is an illustrative screen capture 145 that is similar to the screen capture 140, but includes a row 146 and a row 148. In row 146, a status of execution is displayed that indicates the corresponding command did not complete because it timed out. The run again button 144 allows the user to try that particular command again on the selected entity and device type.

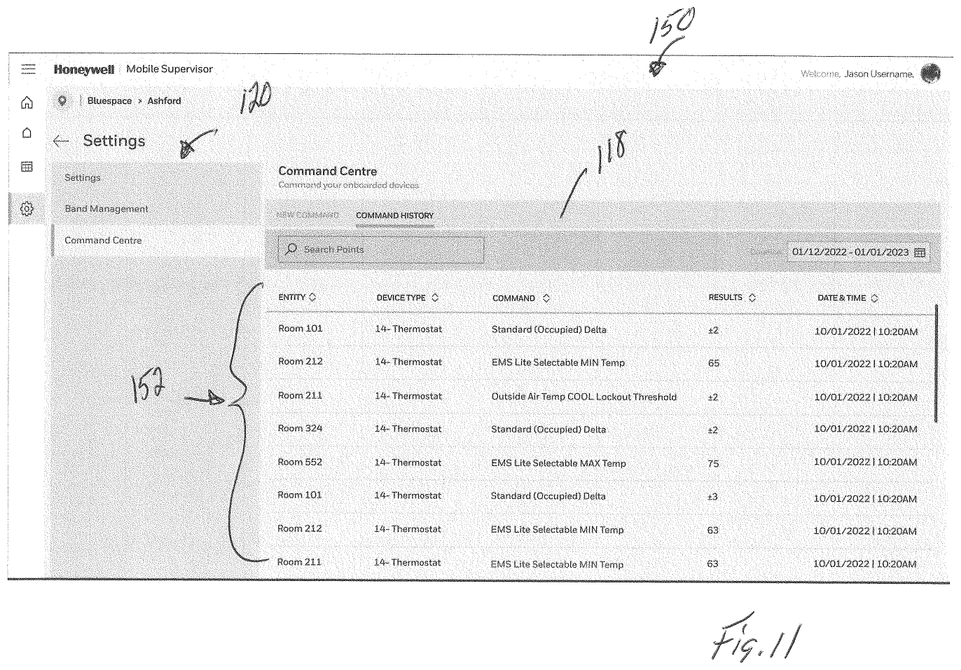

FIG. 11 is an illustrative screen capture 150 that provides an example listing of previous commands in response to the user selecting COMMAND HISTORY in the toolbar 118. The screen capture 150 includes a listing 152 of previous commands, indicating the selected entity, device type, command, results (e.g. status) and date/time.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for configuring one or more guest room control devices in each of a plurality of guest rooms of a hotel facility, wherein each of the guest room control devices is operatively coupled to a server over a network and each of the guest room control devices is configured to control one or more pieces of equipment associated with the respective guest room, the method comprising:
displaying on a display a user interface that includes a guest room control device type selector, a guest room selector and a configuration command selector;
receiving from a user a selection of one or more guest room control device types using the guest room control device type selector, resulting in one or more selected guest room control device types;
receiving from the user via the user interface a selection of one or more guest rooms using the guest room selector, resulting in one or more selected guest rooms of the hotel facility;
receiving from the user via the user interface a selection of a configuration command from a plurality of available configuration commands using the configuration command selector, resulting in a selected configuration command; and
sending over the network a configuration command message that delivers the selected configuration command to each of the guest room control devices that are of the selected guest room control device types in each of the selected guest rooms, that when executed by the respective guest room control device, updates a configuration of the respective guest room control device according to the selected configuration command.

2. The method of claim 1, comprising controlling one or more pieces of equipment by one or more of the guest room control devices using the updated configuration.

3. The method of claim 1, wherein the selected configuration command sets in the respective guest room control device a respective configuration parameter to a respective configuration value.

4. The method of claim 3, wherein the respective configuration parameter comprises one or more of:
a setpoint;
a rented and occupied temperature deadband defined about the setpoint that is used when the guest room is rented and occupied;
a rented and unoccupied temperature deadband defined about the setpoint that is used when the guest room is rented and unoccupied; and
an unrented temperature deadband defined about the setpoint that is used when the guest room is unrented.

5. The method of claim 3, wherein in response to the selection of the selected configuration command using the configuration command selector, requesting and receiving from the user via the user interface the respective configuration value.

6. The method of claim 1, comprising sending an individual configuration command message to each of the guest room control devices that are of the one or more selected guest room control device types in each of the selected guest rooms for execution by the respective guest room control device.

7. The method of claim 6, comprising:
receiving a status of execution of each of the individual configuration command messages from the respective guest room control devices;
displaying the received status of execution of each of the individual configuration command messages via the user interface; and
providing a run again selection option via the user interface for those individual configuration command messages that have a status of execution that indicates the corresponding individual configuration command message did not successfully complete execution on the corresponding guest room control device.

8. The method of claim 1, comprising:
storing a command history, wherein the command history includes a log of each of the configuration command messages sent over the network, along with a status of execution of each of the individual configuration command messages; and
displaying at least part of the command history to the user via the user interface.

9. The method of claim 1, wherein the guest room selector allows the user to select the one or more selected guest rooms individually and/or allows the user to select a predefined group of guest rooms.

10. The method of claim 1, wherein the guest room control device types comprise two or more of a primary thermostat device type, a secondary thermostat device type, a lighting control device type and a window shade controller device type.

11. The method of claim 1, wherein the server performs each of the steps of claim 1.

12. The method of claim 1, wherein a mobile device performs one or more of the steps of claim 1.

13. A system comprising:
one or more guest room control devices in each of a plurality of guest rooms of a hotel facility, wherein each of the guest room control devices is configured to control one or more pieces of equipment associated with the respective guest room;
a display;
a controller operatively coupled to the display and to the one or more guest room control devices, the controller configured to:
display on the display a user interface that includes a guest room control device type selector, a guest room selector and a configuration command selector;
receive from a user a selection of one or more guest room control device types using the guest room control device type selector, resulting in one or more selected guest room control device types;
receive from the user via the user interface a selection of one or more guest rooms using the guest room selector, resulting in one or more selected guest rooms of the hotel facility;
receive from the user via the user interface a selection of a configuration command from a plurality of available configuration commands using the configuration command selector, resulting in a selected configuration command; and
send a configuration command message that delivers the selected configuration command to each of the guest room control devices that are of the selected guest room control device types in each of the selected guest rooms, that when executed by the respective guest room control device, updates a configuration of the respective guest room control device according to the selected configuration command.

14. The system of claim 13, wherein the selected configuration command sets in the respective guest room control device a respective configuration parameter to a respective configuration value.

15. The system of claim 14, wherein the respective configuration parameter comprises one or more of:
a setpoint;
a rented and occupied temperature deadband defined about the setpoint that is used when the guest room is rented and occupied;
a rented and unoccupied temperature deadband defined about the setpoint that is used when the guest room is rented and unoccupied; and
an unrented temperature deadband defined about the setpoint that is used when the guest room is unrented.

16. The system of claim 13, wherein the controller is configured to send an individual configuration command message to each of the guest room control devices that are of the one or more selected guest room control device types in each of the selected guest rooms for execution by the respective guest room control device.

17. The system of claim 16, wherein the controller is configured to:
receive a status of execution of each of the individual configuration command messages from the respective guest room control devices;
display the received status of execution of each of the individual configuration command messages via the user interface; and
provide a run again selection option via the user interface for those individual configuration command messages that have a status of execution that indicates the corresponding individual configuration command message did not successfully complete execution on the corresponding guest room control device.

18. A method for configuring a guest room control device in a guest room of a hotel facility, wherein the guest room control device is operatively coupled to one or more remote guest room control device of other guest rooms of the hotel facility via a mesh network, the guest room control device having a user interface, the method comprising:
selecting a remote guest room control device associated with one of the other guest rooms of the hotel facility via the user interface of the guest room control device;
initiating a configuration copy command of the guest room control device via the user interface of the guest room control device;
in response to initiating the configuration copy command, receiving a plurality of configuration settings from the selected remote guest room control device over the mesh network;
storing the received configuration settings in a memory of the guest room control device, resulting in an updated configuration for the guest room control device; and
controlling one or more pieces of equipment associated with the guest room using the guest room control device having the updated configuration.

19. The method of claim 18, wherein the received configuration settings comprises one or more of:
a rented and occupied temperature deadband defined about a setpoint that is used when the guest room is rented and occupied;
a rented and unoccupied temperature deadband defined about the setpoint that is used when the guest room is rented and unoccupied; and
an unrented temperature deadband defined about the setpoint that is used when the guest room is unrented.

20. The method of claim 18, wherein the received configuration settings comprises one or more of:
an HVAC type setting; and
a fan speed setting.
